(19) United States
(12) Patent Application Publication
(10) Pub. No.: US 2011/0231806 A1
(43) Pub. Date: Sep. 22, 2011

(54) METHOD FOR PARTITIONING ELECTRONIC UNITS

(76) Inventors: Andreas-Juergen ROHATSCHEK, Wernau/Neckar (DE); Bernd LUTZ, Horb (DE); Stoyan TODOROV, Mannheim (DE)

(21) Appl. No.: 12/986,730

(22) Filed: Jan. 7, 2011

(30) Foreign Application Priority Data
Jan. 13, 2010 (DE) 102010000871.0

(51) Int. Cl. G06F 17/50

(52) U.S. Cl. 716/105

(57) ABSTRACT

A method for partitioning electronic units and a system for implementing the method are provided. In the method, a plurality of function modules are distributed to the electronic units, for which purpose different inputs are input into an optimizer, which produces a set of comparable distributions.

### FIELD OF THE INVENTION

The present invention relates to a method for partitioning electronic units, and to a device for implementing the method.

### BACKGROUND INFORMATION

As a result of different requirements of different hardware modules such as CPUs and low-side power drivers, known control devices are made up of a plurality of electronic units, e.g., a plurality of ASICs, notwithstanding the high degree of integration in modern semiconductor technology. One important task, especially at the beginning of a new control device generation, is the distribution of different modules to the different electronic units, for which various optimizing criteria must be observed such as the cost, for example.

At present, expert teams, which are developing new partitionings through discussions and evolution of the current control device generation, have been established for the most part. However, this is a complex and lengthy process, which does not always result in the optimal solution.

Many tests and approaches were used to automate this process. However, methods that could take only one optimization criterion into account were used for this purpose. A criterion could be the cost per area. With the arrival of the system-on chip, however, this interest has shifted considerably to the distribution of functions to hardware and software within an ASIC. The problem of the module distribution to various ASICS remains unsolved, however.

### SUMMARY OF THE INVENTION

Against this backdrop, a method for partitioning electronic units and a system for implementing the method are provided. The system may take the form of a tool in hardware and/or software.

The method allows for an automated distribution of hardware, modules provided in control devices, such as to various integrated switching circuits, several optimization criteria being able to be taken into account in the process.

Thus, a method is provided by which an automated distribution of functional modules to several electronic units such as ASICs is implementable. Toward this end, corresponding models and maps are introduced in order to be able to apply known optimization heuristics such as evolutionary algorithms to the partitioning problem. A plurality of criteria are to be able to be considered independently of each other. This produces a plurality of comparable solutions.

The automated distribution considerably reduces the work with regard to specifying the structure of systems such as control devices. In addition, a plurality of distributions are able to be taken into account in comparable time.

### BRIEF DESCRIPTION OF THE DRAWINGS

FIG. 1 shows a specific embodiment of the method described.

FIG. 2 shows a function model.

FIG. 3 shows an architecture model.

FIG. 4 shows a representation of different models.

### DETAILED DESCRIPTION

The present invention is represented schematically in the figures based on specific embodiments, and is described in detail below with reference to the figures. A detailed description of the structure and function will be provided in the process.

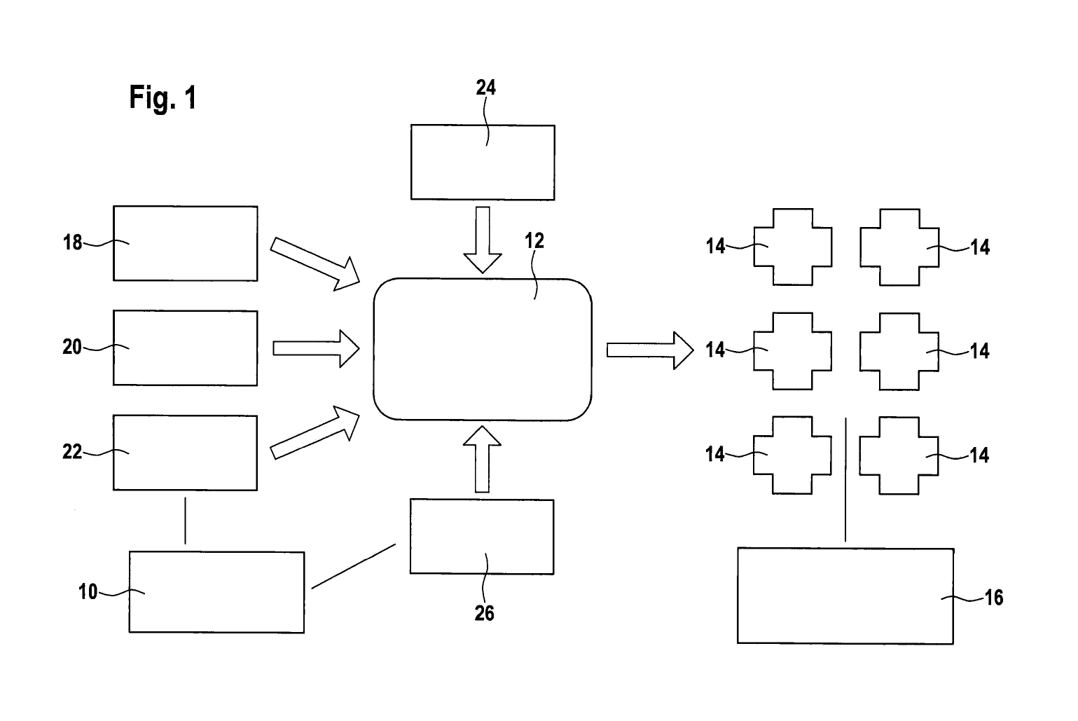

FIG. 1 shows one specific development of the described method, whose structure is made clear. From the illustrations, inputs 10 may be gathered, which serve as basis for an optimizer 12, e.g., a multi-objective evolutionary algorithm, for determining a plurality of comparable module distributions L14 as solution quantity 16.

The method thus includes different inputs 10 to optimizer 12, which uses them to produce a quantity of comparable distributions (Pareto optimality). A function model 18, an architecture model 20, a technology list 22, target functions 24, and marginal conditions 26 are used as inputs 10 in this instance.

Inputs 10 are described in greater detail in the following text with reference to the additional figures.

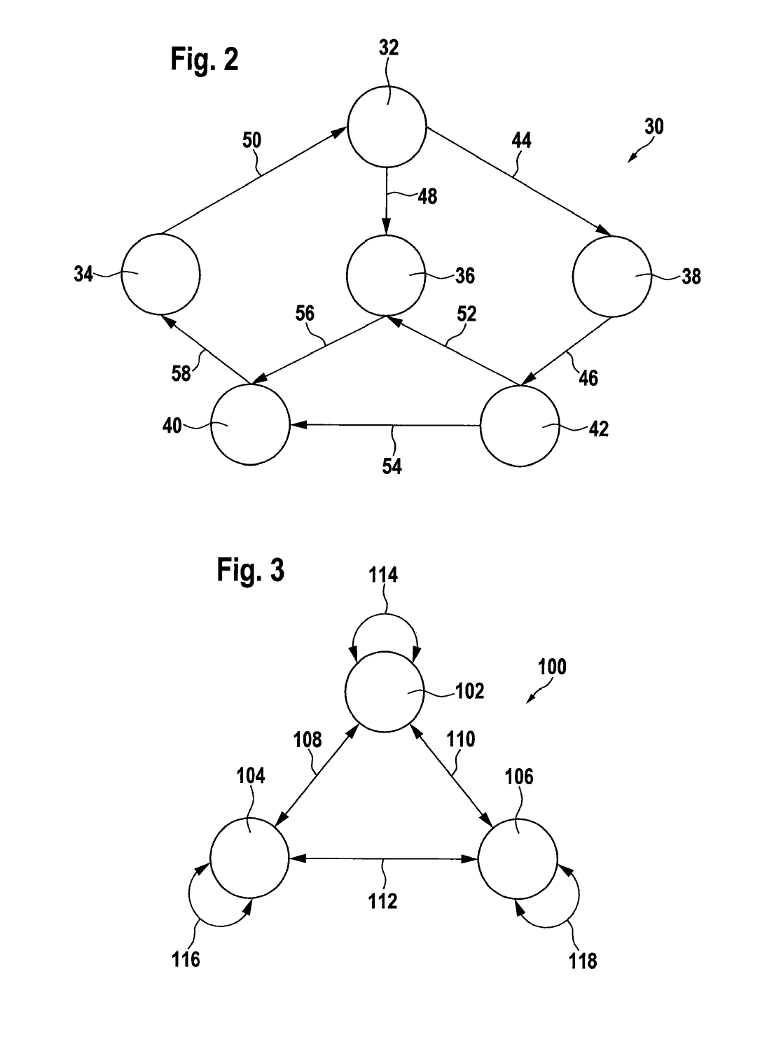

Function model 18 of FIG. 1 serves as representation of the system to be optimized. For this purpose, the system in the form of a graph as it is shown in FIG. 2 is denoted by reference numeral 30. Modules are shown as nodes of the graph in this representation. A communication between modules is illustrated by edges. Both nodes as well as edges may have several properties.

The figure shows as nodes a first module 32, a second module 34, a third module 36, a fourth module 38, a fifth module 40, and a sixth module 42. To illustrate the communication, a first edge 44, a second edge 46, a third edge 48, a fourth edge 50, a fifth edge 52, a sixth edge 54, a seventh edge 56, and an eighth edge 58 are shown. Edges 44 through 58 are directional.

Individual modules 32 through 42, or functional modules, are thus represented by nodes of the graph, and the communication between modules 32 through 42 is represented by edges 44 through 58.

Both nodes and edges have property values, which correspond to the properties of the modules and edges, e.g., the area they take up when implemented in a specific production technology, or the type of communication. A plurality of properties per node or per edge may be indicated for each node and each edge (e.g., number of pins and bit rate in the case of communication edges).

Second module 34, for example, features the properties of area usage, production technologies and waste heat/power. First edge 44 features the properties of number of pins, bit rate, and tolerated latency.

Different properties of the system may make it necessary to combine the modules in the form of clusters. Clusters form units in the resulting partitioning of the modules, which are either logically or physically separate from each other. For example, they may represent separate chips within an ASIC (multi-chip ASIC), or represent areas in the silicon on a chip that are non-conductive because of potential barriers.

The described method has sufficient data structures available for this purpose, in which the modules are combined into clusters. A special input to the method is not necessary, but may be specified if warranted. The number of clusters in an implemented tool corresponds to the number of modules, since each module is able to form a separate cluster in the least favorable case. A higher number of clusters is possible, but not useful. Depending on the application or goal, it is possible to limit the clusters to a smaller number, for example in order to limit the number of potential barriers or chips on ASICs.

Within clusters, modules are able to communicate directly via the metal layers of the production process, which is why no modeling is provided in the cluster model for such a purpose. However, diverse properties such as the cost of pins may become relevant for the communication across cluster, limits. Thus, additional properties such as the cost of pins must be known for these communication possibilities in the method. This depends on whether the communication between clusters takes place within an ASIC or beyond ASIC limits. In the first case; the communication may take place via bond wires; in the second case, the communication must take place via pins and circuit tracks on the associated circuit board. The corresponding parameters are defined accordingly in the architecture model.

FIG. 3 shows an architecture model, which is designated by reference numeral 100 as a whole.

The objective of architecture model 100 is the generation of a superset of allowed ASICs as well as their communication possibilities with each other. Architecture model 100 is shown as complete graph for this purpose. It shows a first ASIC 102, a second ASIC 104, and a third ASIC 106. Furthermore, a first communication channel 108, a second communication channel 110, a third communication channel 112, a fourth communication channel 114 between clusters in first ASIC 102, a fifth communication channel 116 between clusters in second ASIC 104, and a sixth communication channel 118 between clusters in third ASIC 106 are shown.

In architecture model 100, as superset of possible system structures, the number of nodes defines the maximum number of ASICs to be utilized in the particular realization. The edges define communication channels and the expense caused by using the channels.

In this case, additional marginal conditions such as an area limit or power limit, for example, are stored in first ASIC 102. First communication channel 108 and fourth communication channel 114 are assigned cost factors, such as costs per pin and latency.

In the searched for module distribution, the nodes are able to implement one cluster or a plurality of clusters of modules, but they may also remain completely empty. In this case the ASIC is superfluous and need not be realized. A node in the architecture model as such does not have any properties in the implemented tool. All properties such as number of pins or production process are specified via the clusters that are realized in this ASIC. As an alternative, however, it is possible to determine additional properties here, such as a maximally tolerated power consumption of the component or a maximum number of pins.

The edges of the graph represent the communication channels between the ASICs. Since it is theoretically possible for each ASIC to communication with any other ASIC, a complete graph is assumed. The actual communication channels that are to exist between the ASICS are expressed via cost factors for the various edges. Thus, the price per pin or per bit(s) is able to be set. The higher the cost factor, the better it is not to use such an edge. A corresponding target function is able to take this into account.

The possible implementation technologies, such as BCD processes, for instance, are specified for the method in a technology list, which specifies different properties of the process in addition to the name of the process. Depending on the optimization goal, this could be: the resolution of the process, the price per square millimeter, the number of masks, and other properties.

The technology in which it is able to be produced is specified for each module. This is done either in the properties of the node that represents the module, in the variant selected for the tool, or in the technology list.

It must be taken into account that some conditions in the partitioning are able to be handled in an automated manner only with the aid of separate marginal conditions and constraints. Toward this end, the method provides corresponding options:

Separation of modules: For various reasons (e.g., safety aspects) at least two modules are not accepted on one cluster. They must be realized on two different clusters.
Connection of modules: At least two modules must be explicitly realized on one cluster.
Limits for target functions or parts of the target function: Minimum and maximum values may be specified for the target functions. This applies either to the entire target function, or to individual components of the target function. For example, the overall power consumption of a complete system or the power consumption of a special ASIC may be limited. The already mentioned pin limitation of an ASIC may also be mapped by these limits.

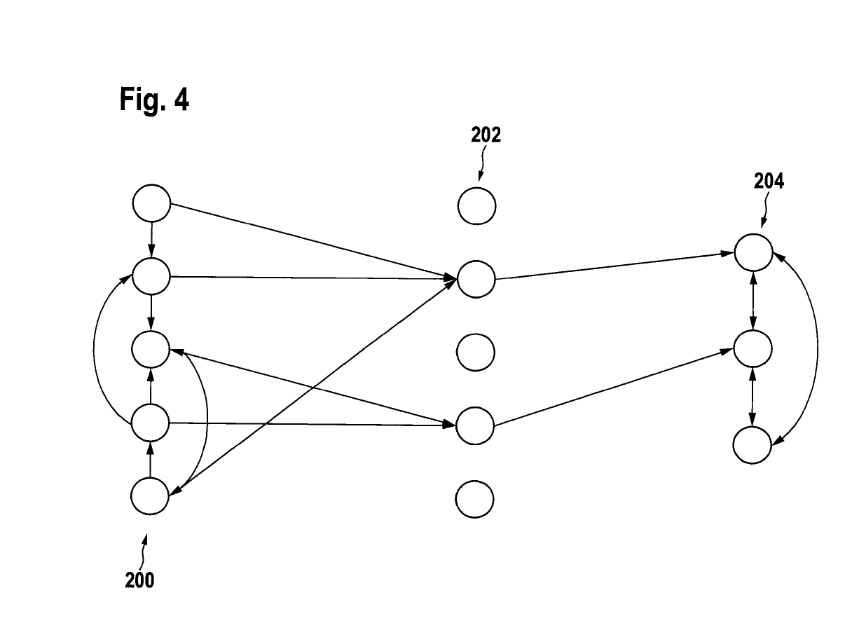

The object of the method is the distribution of modules to individual ASICs. For this purpose, different models may be mapped to each other, as illustrated in FIG. 4. In the development shown, the modules in the functional model are mapped to ASICs in the architecture model using an intermediate step via the cluster model.

In the illustration, a functional model 200 is initially mapped to a cluster model 202. Cluster model 202 is then mapped to an architecture model 204, the mapping being realized by optimization methods. In addition, a technology is assigned to each cluster t_{cl} to t_{c5}. Edges between two assignment levels define where which module will be realized. Clusters without an assigned module do not contribute to the target functions, which is why their assignment to ASICs has not been drawn in for reasons of clarity. However, they are visible for the selected optimization method. Additionally, the optimizer assigns each cluster the technology in which it is to be produced.

The communication edges in the function module are implicitly assigned by the distribution of the modules to communication channels in the architecture model. Depending on the realization locality of the module, a particular communication channel is used.

Target functions map the optimization criteria in mathematical functions. As input, they receive the properties of edges and nodes indicated in the various models, as well as the mapping of modules to clusters and ASICs. These inputs are used to calculate a value for each target function, which is to be minimized in the case at hand. Without restricting the universality, this means that a maximization by minimizing the negative value is possible, i.e., the multiplication of the value to be maximized, by −1. The method is explicitly designed to use a plurality of target functions, without mapping them to a single overall criterion. The objective is the discovery of a plurality of comparable, satisfactory distributions (Pareto optimality).

Different criteria, such as minimizing the area usage, minimizing the number of pins of the ASICs, minimizing the bandwidth of digital interfaces, minimizing the development cost, minimizing the complexity, maximizing the flexibility, minimizing the power consumption, and maximizing the scalability, may be considered as target functions.

The target functions are selected according to the application and possibly adapted.

Due to the models used, their mapping to each other, and the target functions, the method forms a non-linear, non-steady optimization problem that features a plurality of optimization criteria. These optimization criteria are not combined into a single target function, but solved as multi-criteria problem. Various known approaches may be used to solve this multi-criteria problem, e.g., multi-criteria evolutionary algorithms, multi-agent systems, or ant optimizers, the selection of the approach being independent of the introduced method. Thus, depending on the target function, a set of comparable solutions is produced, which subsequently may be dealt with further by a team of experts in an effort to find the preferred solution.

The method is explicitly designed to provide a plurality of comparable satisfactory solutions. These solutions are then presented to a team of experts for further examination. This team can then select one preferred variant of module distributions from the set of solutions.

1. A method for partitioning electronic units, comprising:
distributing a plurality of function modules to the electronic units;
receiving inputs at an optimizer; and
producing a set of comparable distributions at the optimizer.

2. The method according to claim 1, wherein the inputs include a function model.

3. The method according to claim 1, wherein the inputs include a cluster model.

4. The method according to claim 1, wherein the inputs include an architecture model.

5. The method according to claim 1, wherein the inputs include a technology list.

6. The method according to claim 1, wherein the inputs include marginal conditions.

7. The method according to claim 1, wherein the inputs include target functions.

8. The method according to claim 1, wherein the inputs include models, and further comprising mapping between models.

9. The method according to claim 1, further comprising generating a non-linear, non-steady optimization problem featuring a plurality of optimization criteria, which is solved as a multi-criteria problem within the framework of an optimization.

10. A system for partitioning electronic units, comprising:
an optimizer for processing a plurality of inputs and for producing a set of comparable distributions.
